(19) United States
(12) Patent Application Publication
(10) Pub. No.: US 2019/0367800 A1
(43) Pub. Date: Dec. 5, 2019

(54) Lost Circulation Pill for Severe Losses using Viscoelastic Surfactant Technology

(71) Applicant: Halliburton Energy Services, Inc., Houston, TX (US)

(72) Inventors: Eliane Padua Oliveira, Niteroi (BR); Ioana Agustina Gianoglio Pantano, Rio de Janeiro (BR); Jay Paul Deville, Spring, TX (US); Jorge de Almeida Rodrigues, Jr., Rio de Janeiro (BR); Lucas Grillo Celia-Silva, Rio de janeiro (BR); Juan Pablo Luzardo, Rio de Janeiro (BR)

(73) Assignee: Halliburton Energy Services, Inc., Houston, TX (US)

(21) Appl. No.: 16/476,526

(22) PCT Filed: Dec. 28, 2017
(86) PCT No.: PCT/US17/68620

§ 371 Date: Jul. 8, 2019

Related U.S. Application Data
(60) Provisional application No. 62/466,426, filed on Mar. 3, 2017.

(51) Int. Cl. C09K 8/584; C09K 8/506

(52) U.S. Cl. CPC C09K 8/584; C09K 2208/30; C09K 8/506

(57) ABSTRACT

A lost circulation composition includes at least one viscoelastic surfactant that can self-assemble into entangled worm-like micellar structures, increasing the viscosity of the composition at low shear rates. The entanglements of the worm micelles can be reduced at high shear rates, but can be regenerated when the shear rates are reduced. The viscosifying micelle behavior is present at temperatures above 100° C. and regardless of salinity.

### CROSS-REFERENCE TO RELATED APPLICATIONS

The present disclosure is related to provisional U.S. patent application Ser. No. 62/466,426, entitled “Lost Circulation Pill for Severe Losses using Viscoelastic Surfactant Technology,” filed on Mar. 3, 2017.

### BACKGROUND

The present disclosure relates to viscoelastic surfactant fluids useful in subterranean operations, and more particularly, to compositions that enhance fluid loss control and their associated methods of use.

Treatment fluids may be used in a variety of subterranean treatments, including, but not limited to, lost circulation treatments, stimulation treatments and sand control treatments. As used herein, the term “treatment,” or “treating,” refers to any subterranean operation that uses a fluid in conjunction with a desired function and/or for a desired purpose. These subterranean operations can include, but are not limited to, drilling fluid compositions, lost circulation treatments, fluid loss treatments, gravel-packing treatments, sand control treatments, hydraulic fracturing treatments, acidizing treatments, and the like.

Maintaining sufficient viscosity in the treatment fluids used in these operations is important for a number of reasons. Maintaining sufficient viscosity may be important to control and/or reduce fluid loss into the formation, especially in high temperature environments and/or in situations of high salt content, either in the formation or in the brine based drilling fluid, which can act to reduce fluid viscosity. Also, maintaining sufficient viscosity is important for particulate transport and/or to create or enhance fracture width in fracturing and sand control treatments. While maintaining sufficient viscosity of the treatment fluid often is desirable, it may also be desirable to maintain the viscosity of the treatment fluid in such a way that the viscosity may be reduced at a particular time, such as for later recovery of the fluid from the formation.

To provide a desired viscosity, polymeric gelling agents are commonly added to treatment fluids. The term “gelling agent” is defined herein to include any substance that is capable of increasing the viscosity of a fluid, for example, by forming a gel. Examples of commonly used polymeric gelling agents include, but are not limited to, guar gums and derivatives thereof, cellulose derivatives, biopolymers, and the like. To further increase the viscosity of a treatment fluid, a polymeric gelling agent can be crosslinked with the use of a crosslinking agent.

The use of polymeric gelling agents, however, may be problematic. Polymeric gelling agents may leave an undesirable gel residue in the subterranean formation after their use, which can impact the permeability of a formation. Remedial operations may be required to clean up the formation, fracture face, and/or proppant pack, which leads to increased cost.

To combat perceived problems associated with polymeric gelling agents, some surfactants have been used as gelling agents. It is known that, when mixed with a fluid in a concentration above the critical micelle concentration, the molecules (or ions) of surfactants may associate to form micelles. The term “micelle” is defined to include any structure that minimizes the contact between the lyophobic (“solvent-repelling”) portion of a surfactant molecule and the solvent, for example, by aggregating the surfactant molecules into structures such as spheres, cylinders, or sheets, wherein the lyophobic portions are on the interior of the aggregate structure and the lyophilic (“solvent-attracting”) portions are on the exterior of the structure.

When used as a gelling agent, the molecules (or ions) of the surfactants associate to form micelles of a certain micellar structure (e.g., rodlike, wormlike, vesicles, etc., which are referred to herein as “viscosifying micelles”) that, under certain conditions (e.g., ionic strength of the fluid, concentration, etc.) are capable of imparting increased viscosity to a particular fluid and/or forming a gel. Certain viscosifying micelles may impart increased viscosity to a fluid such that the fluid exhibits viscoelastic behavior and shear thinning properties due, at least in part, to the association of the surfactant molecules contained therein. As used herein, the term “viscoelastic surfactant” refers to surfactants that impart or are capable of imparting viscoelastic behavior to a fluid due, at least in part, to the association of surfactant molecules to form viscosifying micelles. Moreover, because the viscosifying micelles may be sensitive to hydrocarbons, the viscosity of these surfactant fluids may be reduced after introduction into the subterranean formation without the need for certain types of gel breakers (e.g., oxidizers).

The term “breaker” is defined herein to include any substance that is capable of decreasing the viscosity of a fluid. This may allow a substantial portion of the surfactant fluids to be produced back from the formation without the need for expensive remedial treatments. These viscoelastic surfactants may not leave the undesirable gel residue in the subterranean formation found in uses of polymeric gelling agents, reducing or alleviating the need for costly remedial operations.

However, the use of viscoelastic surfactant fluids may be problematic in certain subterranean formations exhibiting high temperatures, such as above about 100° C. Many viscoelastic surfactant fluids become unstable at these temperatures, which reduces the viscosity of the fluid. The stability of viscosifying micelles in viscoelastic surfactant fluids can be extremely sensitive to various conditions such as: temperature, pH, presence of other additives in the fluid, composition of the subterranean formation, etc. The inclusion of other additives to the viscoelastic surfactant fluid may detrimentally affect the rheological properties (e.g., viscosity) of the fluid. This inability to maintain a desired level of viscosity at higher temperatures, among other problems, may increase fluid loss and decrease the ability of the fluid to suspend and/or transport particulate materials.

The treatment fluids may have a water or brine base containing selected solids of appropriate particle size ranges for use as a solid weighting agent, or optionally different types of salts to achieve the required densities to obtain a solid-free treatment fluid.

Numerous additives are known in the art and used to help control fluid loss in subterranean operations, and also additives are used to maintain stability and/or viscosity of a treatment fluid at higher temperatures. However, the use of these conventional additives may give rise to other problems. First, the necessity of both a fluid loss control additive and a separate stabilizing or viscosifying additive in a treatment fluid may increase the complexity and cost of a treatment fluid and/or a subterranean operation utilizing that fluid. Moreover, many conventional fluid loss control additives permanently reduce the permeability of a subterranean formation, can affect the rheology of the treatment fluid in which they are used.

Drilling fluids are specialized fluid compositions designed for drilling through subterranean formations. Aspects to be considered when designing drilling fluids can include, drilling a wellbore with a minimum of lost circulation, drilling through the productive formation successfully, minimizing damage to a productive formation, maximizing the production of exposed zones, and to facilitate the necessary well completion. Drilling fluids may have a water or brine base containing selected solids of appropriate particle size ranges (for instance, salt crystals or calcium carbonate) and typically a weighting material such as barite. Usually, additives needed for filtration control and cuttings carrying capability are present in a drilling fluid.

When drilling or completing wells in subterranean formations, various fluids can be used in the well for a variety of reasons. For the purposes herein, such fluid will be referred to as “wellbore fluid” or alternatively “drilling fluid”. Common uses for wellbore fluids include: lubrication and cooling of drill bit cutting surfaces while drilling, transportation of “cuttings” (pieces of formation dislodged by the cutting action of the teeth on a drill bit) to the surface, controlling formation pressure to prevent blowouts, maintaining well stability, suspending solids in the well, minimizing fluid loss into and stabilizing the formation through which the well is being drilled, fracturing the formation in the vicinity of the well, displacing the wellbore fluid within the well with another fluid, cleaning the well, testing the well, use as a packer fluid, use while abandoning the well or preparing the well for abandonment, and otherwise treating the well or the formation.

During the drilling of a subterranean well, such as a hydrocarbon or injection well, the wellbore fluid is generally pumped into the well through the drill pipe and re-circulated to the surface in the annular area between a wellbore wall and a drill string. The wellbore fluid properties are generally monitored during the drilling operations and can be tailored to accommodate the nature of the formation being encountered at the time. When drilling reaches the producing formation, special concern is exercised. Generally it is best to use low solids content fluids to minimize possible productivity loss by solids plugging pores in the formation. Proper wellbore fluid density for overbalancing formation pressure may be obtained by using high salt concentration aqueous brines, while viscosity and fluid loss control generally are attempted by polymer addition, and/or acid soluble particulates such as calcium carbonate or sized salt in a saturated brine solution.

Brines, such as calcium bromide, calcium chloride, zinc chloride and zinc bromide or mixtures of these, are commonly used as wellbore fluids because of their wide density range and the fact that brines are typically substantially free of suspended solids. Additionally, brines typically do not damage certain types of downhole formations. High density brines (for instance having a density greater than 11 ppg) can be used when over-pressured and/or highly permeable and/or poorly consolidated formations are penetrated. The high permeability of many hydrocarbon zones allows large quantities of wellbore fluid to be lost to the formation. Dense brines are often viscosified with crosslinked polymer, but the crosslinking is not easy and predictable. When the crosslinked fluids are lost into the formation by leakoff, it is often very difficult to recover them from the formations. Dense brines, e.g., calcium and zinc salts, can form highly stable, acid-insoluble compounds when reacted with some formation brines. Once the wellbore fluid is lost into the formation, it becomes difficult to remove. Because of the high density of these brines, stratification can tend to further inhibit the removal. Therefore, the most effective means of preventing this type of formation damage is to limit brine losses to the formation. Likewise, losses of wellbore fluids occur when heavy brines are used in other operations such as stimulation, perforation and post-fracturing treatments.

Providing effective fluid loss control is highly desirable to prevent damaging the formation in, for example, completion, drilling, drill-in, displacement, perforations, hydraulic fracturing, work-over, packer fluid placement or maintenance, well treating, or testing operations. Techniques that have been developed to control fluid loss include the use of “fluid loss pills” or “lost circulation pills.” The particulate material used for this purpose can be referred to as “lost circulation material” or LCM. Significant research has been directed to determining suitable materials for the fluid loss pills, as well as controlling and improving the properties of the fluid loss pills. Excessive loss of high-density brine into the formation is a major concern during completion operations, which can lead to well control issues, as well as wellbore damage. The problem becomes more complex when the static bottomhole temperature (BHT) exceeds 100° C. and the job involves running gravel pack assemblies and downhole sand screens.

Typically, lost-circulation pills are composed of very high concentrations of crosslinked polymers, with or without bridging particulates. Conventional fluid loss pills consist typically of a crosslinked polymer, for instance a derivative cellulose such as hydroxyethylcellulose (HEC), shredded into semi-rigid particulates. The pills may further comprise bridging particulates, usually graded sodium or potassium salts, or sized calcium carbonate particulates. The sealing mechanism in these pills is a combination of viscosity, solids bridging, and cake buildup on the porous rock. Due to the instability of polymers at high BHT, incompatibility with some divalent heavy brines, and the necessity to do remedial treatments with acid or similar, a new lost circulation pill composition, that is stable for prolonged periods at high BHT was developed.

Typically, fluid loss pills are used to inhibit the flow from the formation to the wellbore and work by enhancing filter-cake buildup on the face of the formation to inhibit fluid flow into the formation from the wellbore. However, these fluid loss pills can cause severe damage to near-wellbore areas due to polymer filtration or filter-cake formation after their application. At some point in the completion operation, the filter cake must be removed to restore the formation's permeability. If the formation permeability is not restored to its original level, production levels may be significantly reduced. Polymer-based fluid-loss control pills often require long period of cleanup and an effective cleanup usually requires fluid circulation to provide high driving force which allows diffusion to take place to help dissolve the concentrated build up of materials and such fluid circulation may not be feasible.

Subterranean formations having naturally occurring fractures can present a problem because the fractures exacerbate undesired leakage of the drilling fluid into the formation. Thus, lost circulation fluid may be a major challenge when drilling through such naturally fractured formations, such as carbonate formations, due to the presence of natural fractures and vugulars which can be quite large and hence difficult to plug with traditional lost circulation materials.

Because of the high temperature, high shear (caused by the pumping and placement), high pressures, and low pH to which well fluids are exposed, the polymeric materials used to form fluid loss pills and to viscosity the well fluids tend to degrade rather quickly. In particular, for many of the cellulose and cellulose derivatives, such as HEC, used as viscosifiers and fluid control loss agents, significant degradation occurs at temperatures above 100° C. and higher. HEC, for example, is considered sufficiently stable to be used in an environment of no more than about 110° C.

It would be desirable to have a fluid which would have relatively low viscosity in the drill pipe but which after leaving the drill bit could increase in viscosity and inhibit or prevent fluid leak-off into the formation, thereby minimizing formation damage, even in the presence of naturally-occurring fractures or high salt concentrations.

### DETAILED DESCRIPTION

The following detailed description illustrates embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope of the appended claims. An element associated with a particular embodiment should not be limited to association with that particular embodiment but should be assumed to be capable of association with any embodiment discussed herein.

The present disclosure relates to viscoelastic surfactant fluids useful in subterranean operations, and more particularly, to additives that enhance fluid loss control and the stability of viscoelastic surfactant fluids, and their associated methods of use.

The term “viscoelastic surfactant” is defined herein to include any surfactant that imparts or is capable of imparting viscoelastic behavior to a fluid due, at least in part, to the association of surfactant molecules to form viscosifying micelles. The term “viscoelastic surfactant fluid” is defined herein to include any fluid that exhibits or is capable of exhibiting viscoelastic behavior due, at least in part, to the association of surfactant molecules contained therein to form micelles.

The additives used in the present disclosure may, among other things, impact effective or sufficient levels of fluid loss control, stability, and/or viscosity to a viscoelastic surfactant fluid suitable for use in particular subterranean applications, especially at higher temperatures (e.g., above about 100° C.).

Carbonate reservoirs can be particularly challenging from a LCM perspective due to the presence of natural fractures and vugulars that can be quite large and difficult to plug with traditional lost circulation materials. Total losses of the drilling fluids can be encountered making it difficult or impossible to reach the desired true depth. Mitigating extreme losses in non-reservoir sections can be difficult with particulate or reactive chemical treatments. In productive reservoir zones mitigation losses are more challenging since the materials need to be removable and not generate long lasting formation damage. The method of the present disclosure uses the composition of the disclosure in preventing or controlling the loss of wellbore fluid into the pores, fractures, vugulars and any other opening in the subterranean formations.

The composition of the present disclosure includes a viscoelastic surfactant (VES) that self-assemble into worm-like micellar structures that behave as polymers, increasing the viscosity of the fluid. The micelles assume an elongated structure similar to polymer strands. When these elongated micelles become entangled, a viscoelastic behavior develops, and depending on the applied strain, the fluid movement is hindered.

The viscoelastic surfactants included in the VES system may include any suitable surfactant that is capable of imparting viscoelastic properties to the aqueous liquid. These viscoelastic surfactants may be zwitterionic, cationic, anionic, or amphoteric in nature, and include any number of different compounds, including, but not limited to, methyl ester sulfonates, betaines, oleyl betaines, modified betaines, sulfosuccinates, taurates, amine oxides, ethoxylated fatty amines, quaternary ammonium compounds, and combinations thereof.

In an embodiment the VES system includes an amphoteric surfactant that has the general formula (I):

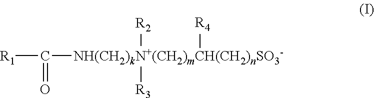

wherein R₁ is a saturated or unsaturated, hydrocarbon group of from about 17 to about 29 carbon atoms, in another embodiment from about 18 to about 21 carbon atoms. In another embodiment R₁ is a fatty aliphatic derived from natural fats or oils having an iodine value of from about 1 to about 140, in another embodiment from about 30 to about 90, and in still another embodiment from 40 to about 70. R₁ may be restricted to a single chain length or may be of mixed chain length such as those groups derived from natural fats and oils or petroleum stocks. Desirable examples include, but are not limited to: tallow alkyl, hardened tallow alkyl, rapeseed alkyl, hardened rapeseed alkyl, tall oil alkyl, hardened tall oil alkyl, coco alkyl, oleyl, erucyl or soya alkyl. R₂ and R₃ are each independently selected from a straight chain or branched, alkyl or hydroxyalkyl group of from 1 to about 6 carbon atoms, in another embodiment, of 1 to 4 carbon atoms and still another embodiment from 1 to 3 carbon atoms. R₄ is selected from H, alkyl or hydroxyalkyl groups of from 1 to about 4 carbon atoms; desirably ethyl, hydroxyethyl, OH or methyl. Of the remaining substituents, k is an integer of from 2-20, in another embodiment 2-12, and in still another embodiment 2-6, and in yet and in still another embodiment 2-4; m is an integer of from 1-20, in another embodiment 1-12, and in still another embodiment 1-6, and in still another embodiment 1-3; and n is an integer of from 0-20, in another embodiment 0-12, and in still another embodiment 0-6, and in still another embodiment 0-1.

In an embodiment the viscoelastic surfactant of general formula (I) is selected from erucamidopropyl hydroxypropyl sulfobetaine, erucamidopropyl hydroxyethyl sulfobetaine, erucamidopropyl hydroxymethyl sulfobetaine and combinations and mixtures thereof.

In an embodiment the surfactant may be the surfactant Armovis® Complete commercially available from Akzo Nobel, or an equivalent type surfactant.

In an embodiment the surfactant may be a zwitterionic surfactant, desirably a betaine, most desirably an oleyl betaine, that has similar properties.

The VES performance may be improved using a co-surfactant. Solids may also be incorporated depending on performance requirements.

VES systems are formed by surfactants that self-assemble into worm-like micellar structures, which behave as polymers, due to the formation of entanglements, increasing the viscosity of the fluid at low shear rates. At high shear rates, the disentanglement of the worm-like-micelles progressively occurs, but the entanglements can be restored when the system is submitted to low shear rates again. At a particular concentration range, or in presence of salt, micelles assume an elongated structure similar to polymer strands (worm-like micelles). When these worm-like micelles become entangled, a viscoelastic behavior develops, and depending on the applied strain, the fluid movement is hindered. A significant increase in viscosity occurs, as does the development of a shear thinning behavior. When the worm micelles are disentangled by shear energy, the apparent viscosity drops significantly to values close to water. Yet viscosity and elastic behavior are recovered when the shear energy is removed. The unique physico-chemo-mechanical properties that create VES viscosity readily lend themselves to shear thinning, static suspension, low static to dynamic transition-energy requirements and high particle transport efficiency. The composition of the disclosure can form a gel, with or without salt or co-surfactant addition, to inhibit lost circulation during drilling, entanglements of worm-like micelles will be formed inside the fractures and vugulars, where shear is lower.

The high viscosity of VES fluids can generally be broken by contact with hydrocarbons or dilution by formation water. Produced oil or condensate lead to a transition in the micellar shape, from worm-like micelles to spherical micelles, as consequence of surfactant migration to the water-oil interface, resulting in oil droplets covered by surfactants. Since spheres are not able to entangle themselves, viscosity drops. Thus the treatment can be broken with the passing of time or with the production of hydrocarbons from the formation. At the production stage, the viscosity will be reduced when fluid comes in contact with the hydrocarbon produced. The micelle shape will revert from worms to spheres and spherical oil droplets would be formed thereby reducing the viscosity. The high viscosity of the VES fluid is easily broken and therefore is easily removable. There is no need for an additional treatment to break the high viscosity and remove the treatment fluid.

In an embodiment the composition of the disclosure also exhibits temperature stability, meaning that the shear-thinning behavior remains constant for temperatures up to at least 100° C., optionally up to at least 110° C., optionally up to at least 120° C.

The density of the pill can be tailored by preparing the LCM pill of the present disclosure using brine containing different type of salts according to the required densities to obtain a solid-free pill. A solids weighting agent also can be added (i.e. calcium carbonate can be used as an acid soluble weighting agent solution for reservoirs).

The LCM pill of the present disclosure can be applied through the drill bit, since it can be a solid-free pill which has no particulate materials that eventually may plug in tight clearances of drilling tools or drill bit nozzles.

An advantage of the present disclosure is the ability to have a relatively stable viscosity (at constant shear) across a wide range of temperatures from the surface to downhole. The composition can be used in a higher temperature environment than previously achievable with viscosified fluids. A further aspect is the ability to have extremely rapid shear recovery and extremely rapid gel recovery enabling the use of the composition even in high shear instances such as tight clearances of tools or bit nozzles. The ease of handling and use on site even in cold climates is advantageous. A further benefit is the ease of removal, as there is no need for a treatment to remove the composition after its intended use. There is also minimal environmental impact with its use and a resulting increase in safety for personnel and the environment.

The present disclosure can provide commercial competitive advantages by being easily removable and not needing a separate treatment to remove, due to being hydrocarbon breakable. A further commercial advantage is that the treatment is easy to apply due to being a single component treatment and able to be pumped through a drill bit. A still further commercial advantage is a reduced risk of prematurely setting or the risk of plugging tight clearances that are inherent in methods such as cement or particulate based solutions. Another advantage is cost savings through the time saved in placing the treatment and not needing to obtain and place breaker treatments.

The aqueous base fluids used in the treatment fluids of the present disclosure may comprise fresh water, saltwater (e.g., water containing one or more salts dissolved therein), brine, seawater, or combinations thereof. Generally, the water may be from any source, provided that it does not contain components that might adversely affect the stability and/or performance of the viscoelastic surfactant fluids. In certain embodiments, the density of the aqueous base fluid can be adjusted, among other purposes, to provide additional particle transport and suspension in the treatment fluids of the present disclosure. In certain embodiments, the pH of the aqueous base fluid may be adjusted (e.g., by a buffer or other pH adjusting agent), among other purposes, to reduce the viscosity of the treatment fluid (e.g., activate a breaker or other additive). In these embodiments, the pH may be adjusted to a specific level, which may depend on, among other factors, the type(s) of viscoelastic surfactant(s), soap component, gelling agents, acids, and other additives included in the treatment fluid. One of ordinary skill in the art, with the benefit of this disclosure, will recognize when such density and/or pH adjustments are appropriate.

Treatment fluids can further be used in wellbore completions, such as hydraulic fracturing, conventional gravel packing, and also “frac-packing”, hydraulic fracturing followed by a gravel packing treatment. The VES-gelled aqueous fluid should maintain its viscosity for a sufficient period of time to perform its intended purpose, for instance, inhibiting or preventing fluid leakoff into the reservoir during the completion operation.

The viscoelastic surfactant fluids used in methods of the present disclosure optionally may comprise any number of additional additives, including, but not limited to, salts, co-surfactants, acids, additional fluid loss control additives, gas, nitrogen, carbon dioxide, surface modifying agents, tackifying agents, foamers, corrosion inhibitors, scale inhibitors, catalysts, clay control agents, biocides, friction reducers, antifoam agents, bridging agents, dispersants, flocculants, H₂S scavengers, CO₂ scavengers, oxygen scavengers, lubricants, viscosifiers, breakers, weighting agents, relative permeability modifiers, resins, particulate materials (e.g., proppant particulates), wetting agents, coating enhancement agents, and the like. A person skilled in the art, with the benefit of this disclosure, will recognize the types of additives that may be included in the viscoelastic surfactant fluids for a particular application.

For example, the treatment fluids of the present disclosure optionally may comprise one or more salts, among other purposes, to modify the rheological properties (e.g., viscosity) of the treatment fluid and/or aqueous fluid weight (i.e. density) for developing hydrostatic pressure to control reservoir fluid pressure during drilling. The salts may be organic or inorganic. Examples of suitable organic salts include but are not limited to aromatic sulfonates and carboxylates (such as p-toluene sulfonate, naphthalene sulfonate), hydroxynaphthalene carboxylates, salicylate, phthalate, chlorobenzoic acid, salicylic acid, phthalic acid, 5-hydroxy-1-naphthoic acid, 6-hydroxy-1-naphthoic acid, 7-hydroxy-1-naphthoic acid, 1-hydroxy-2-naphthoic acid, 3-hydroxy-2-naphthoic acid, 5-hydroxy-2-naphthoic acid, 7-hydroxy-2-naphthoic acid, 1,3-dihydroxy-2-naphthoic acid, 3,4-dichlorobenzoate, trimethylammonium hydrochloride and tetramethylammonium chloride. Examples of suitable inorganic salts include water-soluble potassium, sodium, and ammonium salts, (such as potassium chloride, sodium chloride, and ammonium chloride), calcium chloride, calcium bromide, magnesium chloride, zinc halide salts, sodium formate, potassium formate, cesium formate, sodium salicylate, and combinations thereof. Any combination of the salts listed above also may be included in the treatment fluids of the present disclosure.

When used, the salt may be present in any amount that imparts the desired stability and/or other rheological properties to the treatment fluid of the present disclosure. In certain embodiments, the salt may be present in an amount in the range of from about 0.1% to about 30% by weight of the treatment fluid. In certain embodiments, the salt may be present in an amount in the range of from about 0.1% to about 10% by weight of the treatment fluid. The type(s) and amount of salts suitable in a particular application of the present disclosure may depend upon a variety of factors, such as the type(s) of viscoelastic surfactant(s) present in the treatment fluid, the composition of the aqueous-base fluid, the composition and/or amount of the soap component, the temperature of the fluid, and the like. A person of ordinary skill, with the benefit of this disclosure, will recognize when to include a salt in a particular application of the present disclosure, as well as the appropriate type and amount of salts to include.

The treatment fluids of the present disclosure and/or any component thereof may be prepared at a job site, or they may be prepared at a plant or facility prior to use, and may be stored for some period of time prior to use. In certain embodiments, the preparation of the treatment fluids of the present disclosure may be done at the job site in a method characterized as being performed “on-the-fly.” The term “on-the-fly” is used herein to include methods of combining two or more components wherein a flowing stream of one element is continuously introduced into flowing stream of another component so that the streams are combined and mixed while continuing to flow as a single stream as part of the on-going treatment. Such mixing can also be described as “real-time” mixing.

Viscoelastic surfactants can improve the drilling and/or completion fluid performance using a polymer-free composition. These compositions, compared to polymeric based fluids, can offer improved viscosity breaking, higher sand transport capability (where appropriate), are in many cases more easily recovered after use and are relatively non-damaging to the reservoir after appropriate contact with reservoir hydrocarbons, such as crude oil and condensate. The herein described compositions are also more easily mixed “on-the-fly” in field operations and do not require numerous co-additives in the fluid system, as do some prior systems.

The methods and treatment fluids of the present disclosure may be used during or in preparation for any subterranean operation wherein a fluid may be used. Suitable subterranean operations may include, but are not limited to, preflush treatments, afterflush treatments, drilling operations, lost circulation treatments, hydraulic fracturing treatments, sand control treatments (e.g., gravel packing), acidizing treatments (e.g., matrix acidizing or fracture acidizing), frac-pack treatments, wellbore clean-out treatments, and other operations where a viscoelastic surfactant fluid of the present disclosure may be useful. For example, in certain embodiments, the present disclosure provides fracturing fluids that comprise an aqueous base fluid, a viscoelastic surfactant, and, in certain embodiments, a plurality of proppant particulates. In certain embodiments, a treatment fluid or fracturing fluid of the present disclosure may be used in a method of fracturing a subterranean formation, wherein a viscoelastic surfactant fluid or fracturing fluid of the present disclosure is introduced into the subterranean formation at or above a sufficient hydraulic pressure to create or enhance one or more cracks, or “fractures,” in the subterranean formation. “Enhancing” one or more fractures in a subterranean formation, as that term is used herein, is defined to include the extension or enlargement of one or more natural or previously created fractures in the subterranean formation. This may, among other things, form conductive channels in the subterranean formation through which fluids (e.g., oil, gas, etc.) may flow to a wellbore penetrating the subterranean formation.

The viscoelastic surfactant should be present in a treatment fluid of the present disclosure in an amount sufficient to impart the desired viscosity (e.g., sufficient viscosity to divert flow, reduce fluid loss, suspend particulates, etc.) to the treatment fluid. In certain embodiments, the viscoelastic surfactant may be present in the treatment fluid in an amount in the range of from about 0.05% to about 30% by weight of the treatment fluid. In certain embodiments, the viscoelastic surfactant may be present in the treatment fluid in an amount in the range of from about 0.1% to about 20% by weight of the treatment fluid. In certain embodiments, the viscoelastic surfactant may be present in an amount in the range of from about 0.5% to about 15% by weight of the treatment fluid. In certain embodiments, the viscoelastic surfactant may be present in an amount in the range of from about 1% to about 12% by weight of the treatment fluid. In certain embodiments, the viscoelastic surfactant may be present in an amount in the range of from about 1.5% to about 8% by weight of the treatment fluid. In certain embodiments, the concentration of viscoelastic composition in the fluid is generally from about 0.5% to about 10%, in another embodiment from about 2% to about 8%, and in yet another embodiment from about 3% to about 5% by weight.

In certain embodiments, the viscoelastic surfactant may be present in the treatment fluid in an amount in the range of from about 0.5 to about 25% by volume, alternatively from about 1.0 to about 15% by volume of the total treatment fluid. In another non-limiting embodiment, the range for the present formulations is from about 3.0 to about 10% by volume of the total treatment fluid.

The viscoelastic surfactant gelled fluids herein can optionally contain at least one viscosity enhancer. The viscosity enhancers herein also aid with fluid loss control. Suitable viscosity enhancers include, but are not necessarily limited to, pyroelectric particles, piezoelectric particles, and mixtures thereof. In one non-limiting theory or explanation, when the fluid containing the viscosity enhancers is heated and/or placed under pressure, the particles develop surface charges that associate, link, connect, or relate the VES micelles to one another thereby increasing the viscosity of the fluid. This is somewhat analogous to the way crosslinkers connect various polymer chains, but the way the viscosity enhancers associate the elongated or “worm-like” VES micelles is believed to be completely different than the crosslinking that occurs in polymers.

Suitable viscosity enhancers can include, but are not limited to, ZnO, TiO₂, berlinite (AlPO₄), lithium tantalate (LiTaO₃), gallium orthophosphate (GaPO₄), BaTiO₃, SrTiO₃, PbZrTiO.sub.₃, KNbO₃, LiNbO₃, LiTaO₃, BiFeO₃, sodium tungstate, Ba₂NaNb₅O₅, Pb₂KNb₅O₁₅, potassium sodium tartrate, tourmaline, topaz, and mixtures thereof.

In one embodiment, the methods and compositions herein are practiced in the absence of gel-forming polymers and/or gels or aqueous fluids having their viscosities enhanced by polymers. A known difficulty with polymers is that if they form a filter cake that penetrates the formation, the cake is difficult to remove without permanently damaging the near wellbore region of the formation.

### EXAMPLES

### Example 1

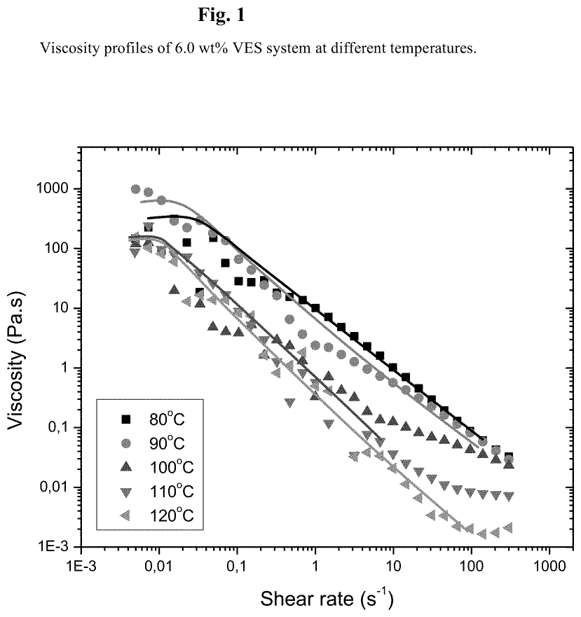

A sample of a VES system was prepared containing 6.0 wt % of surfactant Armovis® Complete and distilled water. The Viscosity of the samples was measured at different shear rates and temperatures. The resulting viscosity profile of the sample at different temperatures is shown in FIG. 1. In FIG. 1, it is shown that at 80° C., at high shear rates (i.e. 100 s⁻¹) the viscosity is relatively low (in the order of 0.1 Pa-s); while at low shear rates (0.01 s⁻¹) the viscosity is considerably higher (more than 200 Pa-s). Similar viscosity changes are seen at the other temperatures, including elevated temperatures of 100° C., 110° C. and 120° C.

### Example 2

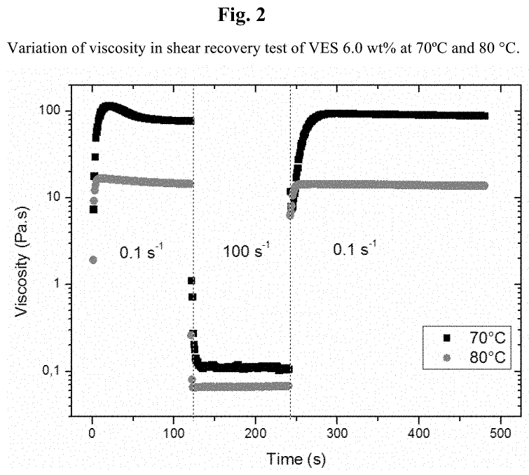

A shear recovery test was performed at 70° C. and 80° C. on the VES sample prepared with 6.0 wt % of VES and distillated water. In the shear recovery test the system was sheared at constant shear rate of 0.1 s⁻¹ for 120 seconds. Then, it was exposed to a constant shear rate of 100 s″ ¹ for 120 seconds. Finally, the shear rate was decreased again to 0.1 s⁻¹, for 240 seconds, in order to evaluate the time required for the system to recover its viscosity. As can be seen in FIG. 2, the viscosity and elastic behavior responded quickly to the differences in shear rate. At 70° C. the low shear viscosity value was approximately 90 Pa-s, the high shear viscosity value dropped to approximately 0.1 Pa-s, upon resumption of the low shear the viscosity value returned to approximately 90 Pa-s. At 80° C. the low shear viscosity value was approximately 15 Pa-s, the high shear viscosity value dropped to approximately 0.06 Pa-s, upon resumption of the low shear the viscosity value returned to approximately 15 Pa-s.

### Example 3

The ability of the VES system to form a plug was tested utilizing a Permeability Plug Test. The sample prepared with 6 wt % of VES and distillated water was tested using a Permeability Plug Apparatus (PPA) at 1,000 psi and 110° C. The pressure was maintained during 30 min of the experiment and no fluid loss was observed.

An embodiment of the present disclosure is a method of drilling into a subterranean formation that includes introducing into a wellbore a fluid composition comprising water and at least one viscoelastic surfactant (VES), where the VES is present in an amount effective to increase the viscosity of the fluid in at least a portion of the fluid to inhibit fluid loss into the formation. The viscoelastic surfactant can be an amphoteric surfactant that has the general formula (I). The resulting increased viscosity can be reduced upon contact with a hydrocarbon. The surfactants can self-assemble into worm-like micellar structures that behave as polymers due to the formation of entanglements, thus increasing the viscosity of the fluid at low shear rates by forming viscosifying micelles. The entanglements of the worm micelles can be reduced at elevated shear rates, but they can be regenerated when the system is exposed to reduced shear rates again. In an embodiment the regenerative behavior remains for temperatures up to 100° C., optionally up to 120° C., optionally up to 140° C., optionally above 140° C. In an embodiment the regenerative behavior remains regardless of salinity.

An embodiment of the present disclosure is a loss circulation pill composition comprising a base fluid such as water and at least one VES, wherein the surfactants self-assemble into worm-like micellar structures that behave as polymers increasing the viscosity of the fluid at low shear rates. In an embodiment the at least one VES is an amphoteric surfactant that has the general formula (I) or an equivalent. The resulting increased viscosity can be broken upon contact with a hydrocarbon. The surfactants can self-assemble into worm-like micellar structures that behave as polymers due to the formation of entanglements, thus increasing the viscosity of the fluid at low shear rates. The entanglements of the worm micelles can be reduced at high shear rates, but they can be regenerated when the system is exposed to low shear rates again. In an embodiment the regenerative behavior remains for temperatures up to 100° C., optionally up to 120° C., optionally up to 140° C. and above. In an embodiment the regenerative behavior remains regardless of salinity.

An embodiment of the present disclosure is a method of reducing fluid loss while drilling into a subterranean formation comprising: introducing into a wellbore a loss circulation pill composition comprising water and at least one VES, the at least one VES being an amphoteric surfactant that has the general formula (I) or an equivalent, thereby increasing the viscosity of the fluid by the action of the VES in at least a portion of the fluid to inhibit fluid loss into the formation, wherein the surfactants self-assemble into worm-like micellar structures increasing the viscosity of the fluid at low shear rates, wherein the entanglements of the worm micelles can be reduced at high shear rates, but they can be regenerated when the system is exposed to low shear rates again, wherein the regenerative behavior remains constant for temperatures up to 100° C. and remains regardless of salinity. In an embodiment the regenerative behavior remains for temperatures up to 140° C.

The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of this disclosure as defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

The text above describes one or more specific embodiments of a broader disclosure. The disclosure also is carried out in a variety of alternate embodiments and thus is not limited to those described here. The foregoing description of an embodiment of the disclosure has been presented for the purposes of illustration and description. It is not intended to be exhaustive or to limit the disclosure to the precise form disclosed. Many modifications and variations are possible in light of the above teaching. It is intended that the scope of the disclosure be limited not by this detailed description, but rather by the claims appended hereto.

What is claimed is:

1. A method of reducing fluid loss into a subterranean formation comprising: introducing into a wellbore a loss circulation pill composition comprising at least one viscoelastic surfactant (VES), where the VES is present in an amount effective to increase the viscosity of the loss circulation pill by forming viscosifying micelles.

2. The method of claim 1, wherein the at least one VES is an amphoteric surfactant that has the general formula (I), 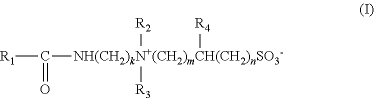
wherein R₁ is a saturated or unsaturated, hydrocarbon group of from about 17 to about 29 carbon atoms, R₂ and R₃ are each independently selected from a straight chain or branched, alkyl or hydroxyalkyl group of from 1 to about 6 carbon atoms, R₄ is selected from H, alkyl or hydroxyalkyl groups of from 1 to about 4 carbon atoms, k is an integer of from 2-20, m is an integer of from 1-20, and n is an integer of from 0-20.

3. The method of claim 2, wherein the VES is selected from the group consisting of: erucamidopropyl hydroxypropyl sulfobetaine, erucamidopropyl hydroxyethyl sulfobetaine, erucamidopropyl hydroxymethyl sulfobetaine, and combinations thereof.

4. The method of claim 1, wherein the VES self-assemble into worm-like micellar structures that behave as polymers due to the formation of entanglements, thus increasing the viscosity of the loss circulation pill composition.

5. The method of claim 4, wherein the entanglements of the micellar structures are reduced upon exposure to increased shear rates and the entanglements are regenerated upon reduction of the shear rates.

6. The method of claim 5, wherein the viscosifying micelle behavior occurs at temperatures up to 140° C.

7. The method of claim 5, wherein the viscosifying micelle behavior is present regardless of the salinity of the composition.

8. The method of claim 1, wherein the VES is present in an amount from 0.05% to 30% by weight of the loss circulation pill composition.

9. The method of claim 1, wherein the viscosity of the loss circulation pill composition is reduced upon contact with a hydrocarbon.

10. A loss circulation pill composition comprising: a base fluid of water and at least one viscoelastic surfactant (VES), wherein the VES self-assemble into worm-like micellar structures that behave as polymers due to the formation of entanglements, thus increasing the viscosity of the composition.

11. The composition of claim 10, wherein the at least one VES is an amphoteric surfactant that has the general formula (I), 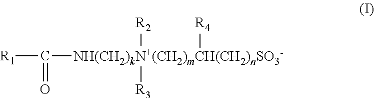
wherein R₁ is a saturated or unsaturated, hydrocarbon group of from about 17 to about 29 carbon atoms, R₂ and R₃ are each independently selected from a straight chain or branched, alkyl or hydroxyalkyl group of from 1 to about 6 carbon atoms, R₄ is selected from H, alkyl or hydroxyalkyl groups of from 1 to about 4 carbon atoms, k is an integer of from 2-20, m is an integer of from 1-20, and n is an integer of from 0-20.

12. The composition of claim 11, wherein the VES is selected from the group consisting of: erucamidopropyl hydroxypropyl sulfobetaine, erucamidopropyl hydroxyethyl sulfobetaine, erucamidopropyl hydroxymethyl sulfobetaine, and combinations thereof.

13. The composition of claim 10, wherein the entanglements of the micellar structures are reduced upon exposure to increased shear rates and the entanglements are regenerated upon reduction of the shear rates.

14. The composition of claim 10, wherein the viscosifying micelle behavior occurs at temperatures up to 140° C.

15. The composition of claim 10, wherein the viscosifying micelle behavior is present regardless of the salinity of the composition.

16. The composition of claim 10, wherein the VES is present in an amount from 0.05% to 30% by weight of the loss circulation pill composition.

17. The composition of claim 10, wherein the increased viscosity of the loss circulation pill composition is reduced upon contact with a hydrocarbon.

18. A method of reducing fluid loss while drilling into a subterranean formation comprising: introducing into a wellbore a loss circulation pill composition comprising water and at least one viscoelastic surfactant (VES), wherein the VES self-assemble into worm-like micellar structures increasing the viscosity of the fluid at low shear rates, wherein the entanglements of the micellar structures are reduced upon exposure to increased shear rates and the entanglements are regenerated upon reduction of the shear rates, wherein the regenerative behavior remains for temperatures above 100° C. and remains regardless of salinity of the composition.

19. The method of claim 18, wherein the at least one viscoelastic surfactant (VES) is an amphoteric surfactant that has the general formula (I), 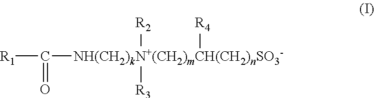
wherein R₁ is a saturated or unsaturated, hydrocarbon group of from about 17 to about 29 carbon atoms, R₂ and R₃ are each independently selected from a straight chain or branched, alkyl or hydroxyalkyl group of from 1 to about 6 carbon atoms, R₄ is selected from H, alkyl or hydroxyalkyl groups of from 1 to about 4 carbon atoms, k is an integer of from 2-20, m is an integer of from 1-20, and n is an integer of from 0-20.

20. The method of claim 18, wherein the VES is present in an amount from 0.05% to 30% by weight of the loss circulation pill composition and wherein the increased viscosity of the loss circulation pill composition is reduced upon contact with a hydrocarbon
